(19) United States
(12) Patent Application Publication
(10) Pub. No.: US 2007/0088772 A1
(43) Pub. Date: Apr. 19, 2007

(54) Fast rotator with embedded masking and method therefor

(75) Inventors: Lincoln R. Nunes, Cedar Park, TX (US); Albert N. Danysh, Austin, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: FREESCALE SEMICONDUCTOR, INC., Austin, TX (US)

(21) Appl. No.: 11/252,061

(22) Filed: Oct. 17, 2005

(51) Int. Cl. G06F 7/00

(52) U.S. Cl. 708/209

(57) ABSTRACT

An operand rotator (100) and method of rotating an operand is disclosed. The operand rotator (100) includes a first decoder (102) with a first input to receive an operand size indicating one of a plurality of operand sizes, a second input for receiving a rotate amount signal and a control output to provide a plurality of control signals. The operand rotator (100) also includes a rotator (104) with a first input coupled to the control output of the first decoder (102), a second input to receive a data element and an output to provide rotated data. The rotator (104) is responsive to the plurality of control signals to rotate portions of the data element corresponding to one of the plurality of operand sizes by an amount corresponding to the rotate amount signal.

### FIELD OF THE DISCLOSURE

The present disclosure is generally related to arithmetic circuits, and more particularly to systems for rotating and shifting operands in an integrated circuit.

### BACKGROUND

A data processor requires a variety of shift operations to implement its instruction set. The shift operations may include left shifts, right shifts, and rotates. The shifts can be arithmetic or logical, which determines how bits either end of the operand are handled. Each shift or rotate operation has a variable length. Which bit is shifted into a given bit position is determined by the type of shift operation and the rotate amount.

There are several kinds of shifters. A simple shift register stores an input operand in parallel, and then shifts the operand serially by one bit position for each clock cycle. When the operand has been shifted by the desired number of bits, the result is read out of the shift register in parallel. Another type of shifter is a barrel shifter. The barrel shifter includes connections from each bit of a source operand to each bit of a destination operand. Thus, the barrel shifter can perform a shift instruction by any arbitrary number of bit positions. Barrel shifters conventionally include two registers each of which function as either the source register or the destination register of the shift operation, depending on the direction. The source and destination registers are coupled to a shifter array, which is essentially an M-by-M matrix of transistors, where M is the operand size. Barrel shifters are fast but require large amounts of circuit area.

A data processor may also be required to support vector operations, also known as single instruction multiple data (SIMD). In order to support such operations, the data processor is required to perform arithmetic and logical operations, including shift and rotate operations, on vector operands. The vector operands can be of varying size. One known technique for performing shifts in vector processors is to have multiple shifters in parallel that support each possible vector size. However, this technique requires multiple barrel shifters and large amounts of circuit area.

### BRIEF DESCRIPTION OF THE DRAWINGS

The present disclosure may be better understood, and its numerous features and advantages made apparent to those skilled in the art by referencing the accompanying drawings.

FIG. 1 is a block diagram of a rotator system according to the present invention;

FIG. 2 is a block diagram of a rotator system according to another embodiment of the present invention;

FIG. 3 illustrates in block diagram form a circuit that forms a part of the decoder and the rotator and masking module of FIG. 2; and

FIG. 4 illustrates in block diagram form a circuit 400 that illustrates circuit 300 of FIG. 3 in greater detail.

The use of the same reference symbols in different drawings indicates similar or identical items.

### DESCRIPTION OF THE DRAWINGS

A system and method of rotating an operand is disclosed. The system includes a first decoder with a first input to receive an operand size indicating one of a plurality of operand sizes, a second input for receiving a rotate amount signal and a control output to provide a plurality of control signals. The system also includes a rotator with a first input connected to the control output of the first decoder, a second input to receive a data element and an output to provide rotated data. The rotator is responsive to the plurality of control signals to rotate portions of the data element corresponding to one of the plurality of operand sizes by an amount corresponding to the rotate amount signal.

In a particular aspect, the first decoder further has a third input for receiving a shift type, and provides the plurality of control signals further in response to the shift type. In another particular aspect, the rotator is further responsive to the plurality of control signals to perform a masking operation on a rotated data element to provide shifted data to the output thereof.

In another particular aspect, the system includes a second decoder with a first input to receive the operand size, a second input to receive a shift amount signal and a control output to provide a plurality of masking control signals. The system also includes a masking module with a first input coupled to the control output of the second decoder, a second input coupled to an output of the rotator module, and an output to provide shifted data. The masking module is responsive to the plurality of masking control signals to shift portions of the data element corresponding to one of the plurality of operand sizes by an amount corresponding to the shift amount signal.

In another aspect, the first decoder includes first decoding logic to decode a first portion of the rotate amount signal and second decoding logic to decode a second portion of the rotate amount signal.

In a particular aspect, the rotator includes a first stage of multiplexers with an input coupled to an output of the first decoding logic, the first stage of multiplexers to partially shift the data element. In another particular aspect, the rotator includes a second stage of multiplexers with a first input coupled to an output of the second decoding logic and a second input coupled to an output of the first stage of multiplexers to receive the partially shifted data element, the second stage of multiplexers to provide the rotated data. In still another particular aspect, the decoder includes third decoding logic to decode a third portion of the rotate amount and the rotator includes a third stage of multiplexers.

In yet another particular aspect, the plurality of operand sizes includes a byte size, a half word size, and a word size. In another particular aspect, the plurality of operand sizes includes a double word size or other multiples of the word size.

In a particular aspect, the rotator is responsive to the plurality of control signals to rotate portions of the vector data in a leftward or rightward direction.

In a particular embodiment, the system includes a decoder with a first input to receive an operand size indicating one of a plurality of operand sizes, a second input for receiving a rotation amount, a third input for receiving a shift amount, a control output to provide plurality of control signals. The system also includes a rotator and mask logic circuit with a first input coupled to the control output of the decoder, a second input to receive a data element and an output to provide rotated or shifted data, wherein the rotator and shifter is responsive to the plurality of control signals to rotate or shift portions of the data element corresponding to one of the plurality of operand sizes by an amount corresponding to the rotation amount or the shift amount signal.

In a particular aspect, the rotator and shifter includes a first stage of multiplexers responsive to a first portion of the plurality of control signals to partially rotate or shift the data element. In another particular aspect, the rotator and shifter further includes a second stage of multiplexers to receive the partially rotated data element and provide the partially rotated or shifted data element and to further rotate or shift the data element.

In a particular aspect, the first stage of multiplexers includes a sign extend input, and the first stage of multiplexers is responsive to the sign extend input to shift the data element.

The method includes receiving first operand size indicating one of a plurality of operand sizes at a first decoder at a first time and receiving a rotate amount signal at the first decoder. The method also includes providing a plurality of control signals from the first decoder to a rotator and rotating portions of a data element corresponding to one of the plurality of operand sizes by an amount corresponding to the rotate amount signal.

In a particular aspect, the method further includes receiving a second operand size at the first decoder at a second time, the second operand size different from the first operand size. In this aspect the method also includes rotating portions of the data element corresponding to the second operand size by an amount corresponding to the rotate amount signal.

In another particular aspect, the method includes receiving a shift amount signal at the first decoder, shifting portions of the vector data corresponding to one of the plurality of operand sizes by an amount corresponding to the shift amount signal. In yet another particular aspect, the portions of the vector data are shifted in a manner corresponding to an algebraic right shift operation. In still another particular aspect, the plurality of operand sizes includes a byte size, a half word size, and a word size. In a particular aspect, the plurality of operand sizes includes a double word size or other multiples of the word size.

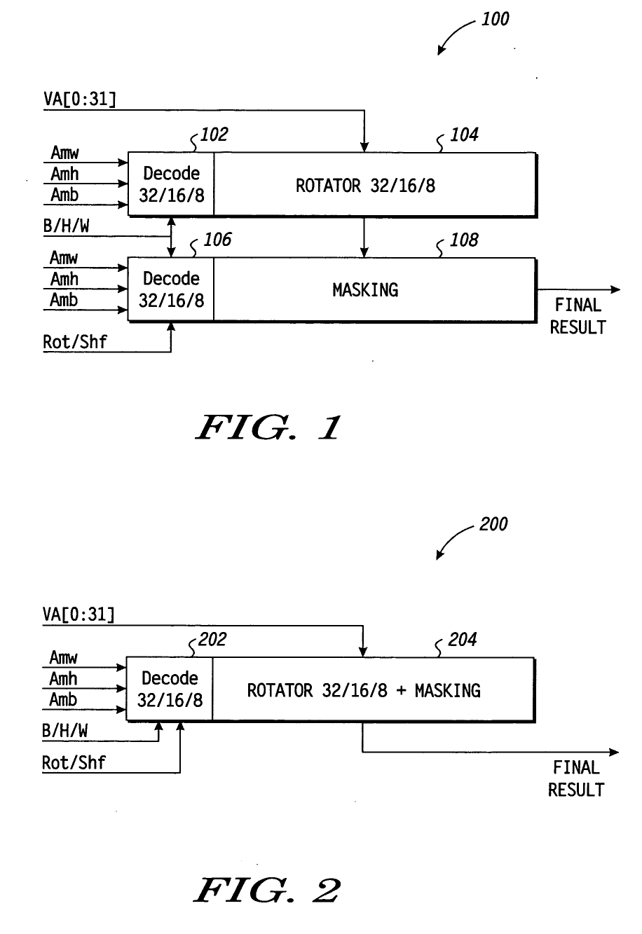

Referring to FIG. 1, an operand rotator 100 according to the present invention is illustrated. The operand rotator 100 includes a first decoder 102, a rotator 104, a second decoder 106, and a masking module 108. The first decoder 102 has first control input terminals for receiving shift amount signals labeled “Amw,” “Amh,” and “Amb,” second control input terminals for receiving operand size signals labeled “B/H/W,” and a plurality of control output terminals. The rotator 104 has a data input for receiving an input operand labeled “VA[0:31],” a set of control input terminals connected to corresponding ones of the control output terminals of decoder 102, and a data output terminal for providing a rotated data signal. The second decoder 106 has first control input terminals for receiving shift amount signals Amw, Amh, and Amb, second control input terminals for receiving shift type signals labeled “Rot/Shf.” The signals labeled Rot/Shf include an op code indicating whether the operation should be a shift or rotate operation, a shift left or shift right operation, and a logical shift or arithmetic shift operation. The second decoder 106 also includes a plurality of control output terminals. The masking module 108 data output terminal for providing a data output signal labeled “FINAL RESULT.”

In operation rotator 100 is a vector rotator capable of performing rotation and shift operations on operands capable of being represented in different vector formats. In the embodiment illustrated in FIG. 1, the operand rotator 100 supports shifts and rotates on 8-, 16-, and 32-bit (i.e., byte, half-word, and word) vector operands. Other operand sizes, such as double word sizes or other multiples of the word size, can be supported in alternative embodiments.

In addition, the operand rotator 100 is capable of rotating different portions of the vector operand by different amounts. For example, for a 32-bit operand, the operand rotator 100 may shift the first half-word of the operand by a first amount and the second half-word of the operand by a second amount.

The operand rotator 100 performs shifts and operates in two steps. In the first step, the bits are rotated in a rotation operation by the rotator 104. In the second step, certain bit positions are masked to handle boundary conditions by the masking module 108 to convert the simple rotation operation into arithmetic shifts or logical shifts as determined by the instruction. To perform the rotation operation the first decoder 102 decodes the control signals Amw, Amh, and Amb as well as the vector size B/H/W. Based on the decoded control signals, the rotator 104 rotates each portion of the vector operand by the appropriate amount.

The operand rotator 100 converts simple rotation operations into shift operations by using the second decoder 106 and the masking module 108. The masking module 108 is responsive to the control signals Amw, Amh, and Amb as well as the shift type signals Rot/Shf to determine the type of shift and boundary conditions of the shift to be performed. The masking module 108 applies a mask to determine the value to be inserted into vacated bit positions, such as a sign bit after the arithmetic shift operation.

By performing additional decoding using both the rotate amount and the vector size, rotator 100 is able to generate control signals in a single 32-by-32 matrix to handle all supported shift amounts and vector sizes. Thus, while decoder 102 may be somewhat larger than that of a comparable barrel shifter, the matrix in rotator 104 is approximately the same size as a shift array used for a 32-by-32 barrel shifter. Moreover, the operand rotator 100 saves significant amounts of circuit area in vector processors because it can be used for all supported vector sizes, and may independently shift or rotate different portions of a particular operand. In addition, the operand rotator saves power and is faster than some other solutions.

Referring to FIG. 2, an alternative embodiment of an operand rotator 200 is illustrated. The operand rotator includes a decoder 202 and a rotator and masking module 204. The decoder 202 includes first control input terminals for receiving shift amount signals labeled “Amw,” “Amh,” and “Amb,” second control input terminals for receiving operand size signals labeled “B/H/W,” third control input terminals for receiving a shift type signals labeled “Rot/Shf” and a plurality of control output terminals. The rotator and masking module 204 has a data input for receiving an input operand labeled “VA[0:31],” a set of control input terminals connected to corresponding ones of the control output terminals of the decoder 202, and a data output terminal for providing a data output signal labeled “FINAL RESULT.”

In operation, the operand rotator 200 is a vector rotator capable of performing rotation and shift operations on operands capable of being represented in different vector formats. As with respect to operand rotator 100, the operand rotator 200 supports shifts and rotates on 8-, 16-, and 32-bit (i.e., byte, half-word, and word) vector operands but other operand sizes, such as double word sizes, can be supported in alternative embodiments.

To perform a rotation operation the decoder 202 decodes the control signals Amw, Amh, and Amb, as well as the control signals B/H/W and Rot/Shf. Based on the decoded control signals, the rotator and masking module 204 rotates each portion of the vector operand by the appropriate amount and performs masking to handle boundary conditions for various supported shift operations.

In addition to the advantages of the operand rotator 100 of FIG. 1, operand rotator 200 integrates the rotation and masking functions into a single circuit, saving additional circuit area, additional power, and providing additional speed.

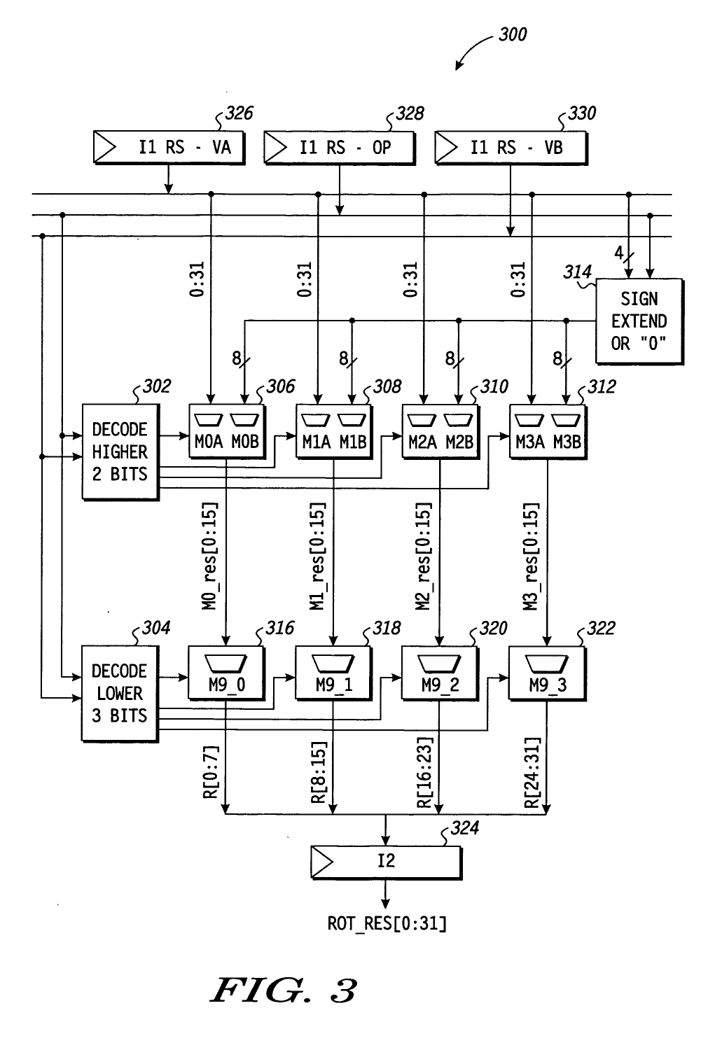

FIG. 3 illustrates in block diagram form a circuit 300 that forms a part of decoder 202 and rotator and masking module 204 of FIG. 2. The circuit includes a first decoder 302, a second decoder 304, and a first stage of multiplexers including a first multiplexer 306, a second multiplexer 308, a third multiplexer 310 and a fourth multiplexer 312. The system further includes a sign extend module 314 and a second stage of multiplexers including a fifth multiplexer 316, a sixth multiplexer 318, a seventh multiplexer 320, and an eighth multiplexer 322. The system also includes an output register 324, and input registers 326, 328, and 330.

The first decoder 302 has first control input terminals for receiving shift type signals labeled “I1 RS-OP” stored in the second input register 328, second control input terminals for receiving shift amount signals labeled “I1 RS-VB” stored in the third input register 330, and a plurality of control output terminals. The second decoder 304 also has first control input terminals for receiving shift amount labeled “I1 RS-OP,” second control input terminals for receiving shift amount signals labeled “I1 RS-VB,” and a plurality of control output terminals. The sign extend module 314 includes control inputs for receiving shift type signals labeled “I1 RS-OP,” data inputs for receiving 4 bits of an input operand labeled “I1 RS-VA” stored in the first input register 326, and a data output terminal.

The multiplexers 306,308,310, and 312 are each comprised of two multiplexers, labeled “M0A,” “M0B,” “M1A,” “M1B,” “M2A,” “M2B,” “M3A,” and “M3B” respectively. Each of the multiplexers 306,308, 310 and 312 have first data inputs for receiving the input operand labeled I1 RS-VA, second data inputs corresponding to the data output terminal of the sign extend module 314, and a plurality of control input terminals connected to corresponding ones of the control output terminals of the first decoder 302. The first multiplexer 306 includes a data output terminal for providing a data output signal labeled “M0_res[0:15].” The second multiplexer 308 includes a data output terminal for providing a data output signal labeled “M1_res[0:15].” The third multiplex 310 includes a data output terminal for providing a data output signal labeled “M2_res[0:15].” The fourth multiplexer 312 includes a data output terminal for providing a data output signal labeled “M3_res[0: 15].”

The multiplex 316, 318, 320 and 322 each have first data inputs for receiving the corresponding data output of the multiplexers 306, 308, 310 and 312 respectively and a plurality of control input terminals connected to corresponding ones of the control output terminals of the second decoder 304. The fifth multiplexer 316 includes a data output terminal for providing a data output signal labeled “R[0:7]” The sixth multiplexer 318 includes a data output terminal for providing a data output signal labeled “R[8:15].” The seventh multiplex 320 includes a data output terminal for providing a data output signal labeled “R[16:23].” The eighth multiplexer 322 includes a data output terminal for providing a data output signal labeled “R[24:31].”

During operation, the first decoder 302 receives the higher or more significant bits of a rotate amount signal, an operand size and shift type signal. The decoder 302 decodes these received bits to provide control signals to the first stage of multiplexers. The first stage of multiplexers 306, 308, 310 and 312 receives a vector data element and the sign extend signal from the sign extend module 314 based on the control signals provided by the first decoder 302 provides a shifted output based on the received data element.

The first stage of multiplexers performs a coarse shifting operation. In particular, the first stage of multiplexers operates to perform a shift operation on coarse portions of the data element. For example, if the data element is 32 bits long, the first stage of multiplexers shifts each byte or word that comprises the data element.

In addition, the multiplex receives data from the sign extend module 314. The sign extend module 314 is used to apply a masking or shift operation to the first stage of multiplexers. For example, the sign extend module 314 can be used to place ones or zeroes in the data element in such a way as to perform a masking operation on the data element in order to modify a rotate operation into a shift operation.

The second decoder 304 decodes the lower three bits of a rotation amount. The second decoder 304 also receives an operand size and shift type. Based on these inputs, the second decoder 304 provides control signals to the second stage of multiplexers 316, 318, 320, and 322.

The second stage of multiplexers receives an output of the first stage of multiplexers. The second stage of multiplexers then rotates the output of the first stage of multiplexers based on the control signals provided by the second decoder 304. The second stage of multiplexers performs a “fine” shift operation. In particular, each of the multiplexers 316, 318, 320, 322 receives a 16 bits from the first stage of multiplexers and performs a shift or rotate operation on the received bits. After the bits have been rotated, the rotated bits are integrated into a single operand at the register 324. The register 324 thus stores the rotated and shifted result.

By using two stages of multiplexers in a “coarse” and “fine” configuration as illustrated, individual portions of an operand are rotated independently and by different rotation amounts. In addition, the use of the sign extend module 314 allows for integrated masking of the operand. This reduces the amount of circuit area required by the rotator. Further, the circuit 300 is capable of supporting different rotation and shift amounts, reducing the total circuit area required for rotation and shift operations, resulting a circuit that uses less power and is faster.

Other multiplexer configurations are possible. For example, the rotate and shift operations may be performed using a single stage of multiplexers. More than two stages of multiplexers may also be used. Further, the multiplexers may be configured so that first and second decoders are reversed.

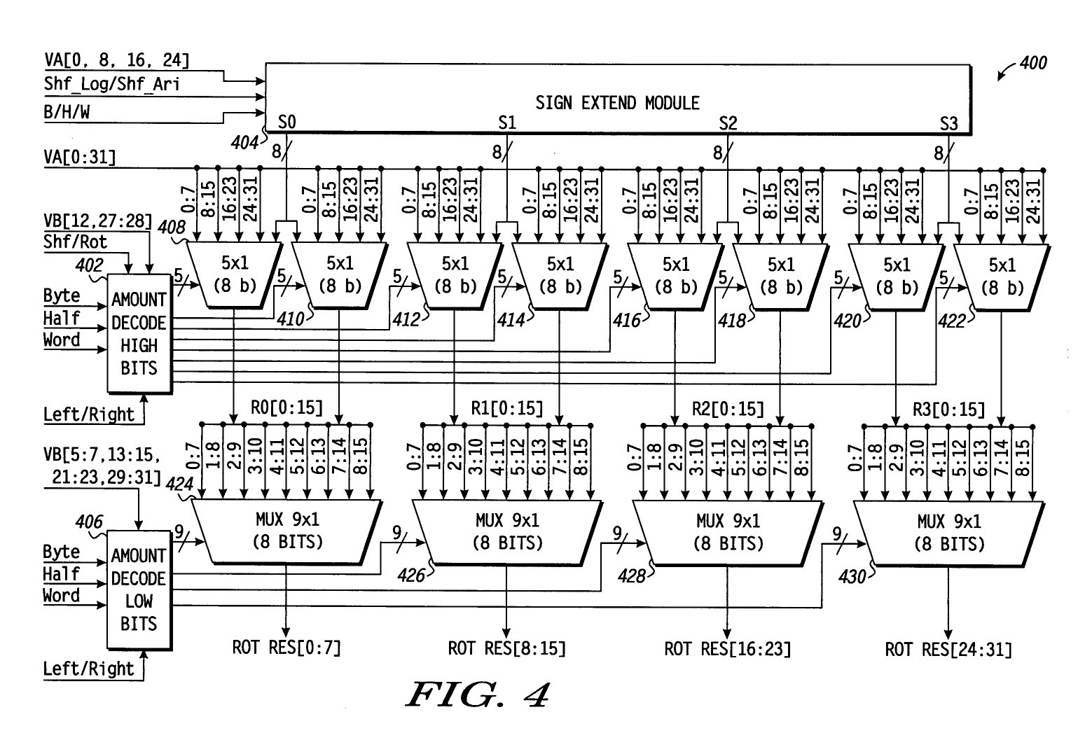

FIG. 4 illustrates in block diagram form a circuit 400 that illustrates circuit 300 of FIG. 3 in greater detail. The system 400 can be used to implement the rotate circuit 300 of FIG. 3. The system 400 includes a first decoder module 402, a second decoder module 406 and a sign extend module 404. The system also includes a first stage of multiplexers, comprised of multiplexers 408, 410, 412, 414, 416, 418, 420, and 422. The system 400 further includes a second stage of multiplexers, comprised of multiplexers 424, 426, 428, and 430.

The first decoder module 402 includes first control input terminals for receiving shift amount signals, labeled “VB[12,27:28],” second control input terminals for receiving shift type signals, labeled “Shf/Rot,” third control input terminals for receiving an operand size, labeled “Byte,” “Half,” and “Word,” and fourth control input terminals for receiving shift directions signals, labeled “Left/Right.” The first decoder module 402 further includes a plurality of control outputs for providing control signals. The second decoder module 406 includes first control input terminals for receiving shift amount signals, labeled “VB[5:7, 13:15, 21:23, 29:31],” second control input terminals for receiving an operand size, labeled “Byte,” “Half,” and “Word,” and third control input terminals for receiving shift directions signals, labeled “Left/Right.” The second decoder module 406 further includes a plurality of control outputs for providing control signals

The system 400 receives an input operand labeled “VA[0:31]. ” Each of the first stage of multiplexers, including multiplexers 408, 410, 412, 414, 416, 418, 420 and 422, receive a plurality of data inputs based on the input operand. For example, the multiplexer 408 receives a plurality of data inputs, each input including a portion of the bits that comprise the input operand. Therefore, as illustrated, the multiplexer 408 receives a data input labeled “0:7” which consists of bits 0 through 7 of the input operand. The other multiplexers included in the first stage of multiplexers receive similar data inputs.

In addition, the sign extend module 404 includes first data inputs for receiving a plurality of sign bits, labeled “VA[0,8,16,24],” first control inputs for receiving a shift type signal, labeled “Shf_Log/Shf_Ari,” and second control input signals for receiving an operand size, labeled “B/H/W.” The sign extend module 404 also includes a plurality of data outputs, labeled “S0,” “S1,” “S2” and “S3.” Each of the first stage of multiplexers includes a data input connected to a corresponding one of the data outputs of the sign extend module 404. Thus, the multiplexers 408 and 410 each include a data input corresponding to the “S0” data output of the sign extend module 404. Similarly, the multiplexers 412 and 414 each include a data input corresponding to the “S1” data output, the multiplexers 416 and 418 each include a data input corresponding to the “S2” data output, and the multiplexers 420 and 422 each include a data input corresponding to the “S3” data output of the sign extend module 404. Further, each of the first stage of multiplexers include a plurality of control inputs that are connected to corresponding ones of the control outputs of the first decoder 402. Each of the first stage of multiplexers also includes a data output.

Each of the second stage of multiplexers, including the multiplexer 424, the multiplexer 426, the multiplexer 428, and the multiplexer 430, each include a plurality of data inputs based on a data output of one or more of the first stage of multiplexers. Thus, the data input of the multiplexer 424 is connected to the data output of the multiplexer 408 and the multiplex 410. The data output of the multiplexers 408 and 410, as illustrated, form a sixteen bit half word labeled “R0[0:15].” The input to the multiplexer 424 is based on certain bits of the half word R0[0:15]. For example, as illustrated, the first input of the multiplexer 424 consists of bits 0:7 of the half word R0[0:15], while the second input consists of bits 1:8 of the half word R0[0:15]. The multiplexers 426, 428, and 430 are configured in a similar fashion, based on different outputs of the first stage of multiplexers. Each of the second stage of multiplexers also includes a plurality of control inputs connected to corresponding ones of the control outputs of the second decoder module 406.

Further, each of the second stage of multiplexers includes a data output. For example, the multiplexer 424 provides a data output labeled ROT RES[0:7]. The outputs of each of the multiplexer 424, 426, 428 and 430 may be integrated in an appropriate fashion, such as placed in a 32 bit register, to produce a rotation result.

During operation, the first decoder module 402 decodes the received shift amount, shift type, operand size, and shift direction signals to produce control signals for the first stage of multiplexers. Based on these control signals, each of the first stage of multiplexers selects one of the pluralities of inputs to provide as an output. Thus, for example, the multiplexer 414 can select the input 0:7, 8:15, 16:23, or 23:31 to provide as an output. In this fashion, each of the first stage of multiplexers performs a coarse shift on the input operand VA[0:31]. In addition, the sign extend module 404 provides data to the first stage of multiplexers based on the control signals provided sign extend module. The data provided by the sign extend module 404 is selected by each multiplexer of the first stage of multiplexers to apply the proper boundary conditions according to the shift type, shift direction, and other control signals. The output of each of the first stage of multiplexers is therefore based on one of the inputs provided to each multiplexer and the data provided by the sign extend module.

The second decoder module 406 decodes the received shift amount, operand size, and shift direction signals to produce control signals for the second stage of multiplexers. Based on these control signals, each of the second stage of multiplexers selects one of the pluralities of inputs to provide as an output. Thus, for example, the multiplexer 424 can select the input 0:7, 1:8, 2:9, 3:10, 4:11, 5:12, 6:13, 7:14, or 8:15 to provide as an output. In this fashion, each of the second stage of multiplexers performs a fine shift on the corresponding output of the first stage of multiplexers. The outputs of the second stage multiplexers are integrated to form the final rotated or shifted result.

As explained above, the use of a “coarse” rotation stage and a “fine” rotation stage results in a smaller, faster circuit that uses less power. In addition, fewer or more stages of multiplexers may be used in different applications.

Although the system of FIG. 4 has been described in reference to operation on vector elements, the system may also be configured to perform operations on scalar elements. In that case, assuming that the scalar operands are always the same size, the decoders may not be provided an operand size. Furthermore, another data input may be provided to each of the second stage multiplexers. These data inputs may injection bits from the sign extend module or other appropriate source to perform a second masking operation. This second masking operation allows the system to perform “injected masking” operations, or other operations, to perform the appropriate shifts for a scalar instruction set. In this configuration, the second stage multiplexers are larger than those illustrated in FIG. 4 to accommodate the new data input but the first stage is simplified and can have just half plus one of the multiplexers used in FIG. 4.

While the principles of the invention have been described above in connection with specific apparatus, it is to be clearly understood that this description is made only by way of example and not as a limitation on the scope of the invention.

What is claimed is:

1. An operand rotator, comprising:
a first decoder with a first input to receive an operand size indicating one of a plurality of operand sizes, a second input for receiving a rotate amount signal and a control output to provide a plurality of control signals; and
a rotator with a first input coupled to the control output of the first decoder, a second input to receive a data element and an output, wherein the rotator is responsive to the plurality of control signals to rotate portions of the data element corresponding to one of the plurality of operand sizes by an amount corresponding to the rotate amount signal.

2. The operand rotator of claim 1, wherein the first decoder further has a third input for receiving a shift type, and provides the plurality of control signals further in response to the shift type.

3. The operand rotator of claim 2, wherein the rotator is further responsive to the plurality of control signals to perform a masking operation on a rotated data element to provide shifted data to the output thereof.

4. The operand rotator of claim 1, further comprising:
a second decoder with a first input to receive the operand size, a second input to receive a shift amount signal and a control output to provide a plurality of masking control signals; and
a masking module with a first input coupled to the control output of the second decoder, a second input coupled to the output of the rotator, and an output to provide shifted data, wherein the masking module is responsive to the plurality of masking control signals to shift portions of the data element corresponding to one of the plurality of operand sizes by an amount corresponding to the shift amount signal.

5. The operand rotator of claim 1, wherein the first decoder includes first decoding logic to decode a first portion of the rotate amount signal and second decoding logic to decode a second portion of the rotate amount signal.

6. The operand rotator of claim 5, wherein the rotator includes a first stage of multiplexers with an input coupled to an output of the first decoding logic, the first stage of multiplexers to partially shift the data element.

7. The operand rotator of claim 6, wherein the rotator includes a second stage of multiplexers with a first input coupled to an output of the second decoding logic and a second input coupled to an output of the first stage of multiplexers to receive the partially shifted data element, the second stage of multiplexers to provide the rotated data.

8. The operand rotator of claim 1, wherein the plurality of operand sizes includes a byte size, a half word size, and a word size.

9. The operand rotator of claim 1, wherein the plurality of operand sizes includes a double word size.

10. The operand rotator of claim 1, wherein the rotator is responsive to the plurality of control signals to rotate portions of the vector data in a leftward or rightward direction.

11. An operand rotator, comprising:
a decoder with a first input to receive an operand size indicating one of a plurality of operand sizes, a second input for receiving a rotation amount, a third input for receiving a shift type, a control output to provide plurality of control signals; and
a rotator and mask logic circuit with a first input coupled to the control output of the decoder, a second input to receive a data element and an output to provide rotated or shifted data, wherein the rotator and shifter is responsive to the plurality of control signals to rotate or shift portions of the data element corresponding to one of the plurality of operand sizes by an amount corresponding to the rotation amount signal.

12. The operand rotator of claim 11, wherein the rotator and shifter includes a first stage of multiplexers responsive to a first portion of the plurality of control signals to partially rotate or shift the data element.

13. The operand rotator of claim 12, wherein the rotator and shifter furtherincludes a second stage of multiplexers to receive the partially rotated data element and provide the partially rotated or shifted data element and to further rotate or shift the data element.

14. The operand rotator of claim 12, wherein the first stage of multiplexers includes a sign extend input, and wherein the first stage of multiplexers is responsive to the shift type signal to shift the data element based on the sign extend input.

15. A method for rotating a data unit, comprising:
receiving a first operand size indicating one of a plurality of operand sizes at a first decoder at a first time;
receiving a rotate amount signal at the first decoder;
providing a plurality of control signals from the first decoder to a rotator; and
rotating portions of a first data element corresponding to the first operand size by an amount corresponding to the rotate amount signal.

16. The method of claim 15, further comprising:
receiving a second operand size indicating one of a plurality of operand sizes at the first decoder at a second time, the second operand size different from the first operand size; and
rotating portions of a second data element corresponding to the second operand size by an amount corresponding to the rotate amount signal.

17. The method of claim 15, further comprising:
receiving a shift amount signal at the first decoder;
shifting portions of the vector data corresponding to one of the plurality of operand sizes by an amount corresponding to the shift amount signal.

18. The method of claim 17, wherein the portions of the vector data are shifted in a manner corresponding to an algebraic right shift operation.

19. The method of claim 15, wherein the plurality of operand sizes includes a byte size, a half word size, and a word size.

20. The method of claim 15, wherein the plurality of operand sizes includes a double word size.
